(19) United States
(12) Patent Application Publication
(10) Pub. No.: US 2014/0364187 A1
(43) Pub. Date: Dec. 11, 2014

(54) REAL-TIME BETTING, DRAWING AND WINNING SYSTEM AND METHOD THEREOF

(71) Applicant: REAL TIME WINNING SYSTEM INC., Apia (WS)

(72) Inventor: Ching-Te Chang, Taipei (TW)

(73) Assignee: REAL TIME WINNING SYSTEM INC., Apia (WS)

(21) Appl. No.: 14/014,609

(22) Filed: Aug. 30, 2013

(30) Foreign Application Priority Data
Jun. 11, 2013 (TW) 102120672

(51) Int. Cl. G07F 17/32

(52) U.S. Cl. CPC G07F 17/3288
USPC 463/17

(57) ABSTRACT

Real-time betting, drawing and winning system and method are provided for a bettor to conduct an online betting service. The bettor is connected to a service server via a user device. The service server generates a lottery number in advance, and generates a verification public key, a signing code and a verification private key according to the lottery number. The bettor selects a betting mechanism, and selects a betting item corresponding to the betting mechanism to generate a betting content. The betting content is compared with the lottery number to generate lottery information. The lottery number and the lottery information are transmitted to the user device. The bettor can identify, by using the verification public key, the signing code and the verification private key, to determine whether the lottery number is identical to the betting content. Through the use of the real-time betting, drawing and winning system and method, an online betting result can be obtained immediately, and a betting process can be proved by verification to be fair and trustworthy.

### BACKGROUND OF THE INVENTION

1. Field of the Invention

This invention relates to network betting techniques, and, more particularly, to a real-time betting, drawing and winning system and method thereof.

2. Description of Related Art

With the rapid development of technology, more and more services are conducted online via a network. An online service can be conducted at any time and any place, and is thus popular for many users, especially those who are busy, stay in a remote area, and want to know the result immediately.

There are already a various of network services in the market, including online learning, network shopping, online amusement, etc. These network services, if providing real-time feedback information, can attract more users. For example, people who login an online learning website would like to know the test result immediately, and people shopping online would like to know immediately whether a transaction is done. Therefore, a real-time feedback mechanism is an essential feature for network services. Besides, people also care about network security, including whether personal data used in a network shopping event is encrypted, whether an additional clause is encrypted, etc. In an online number-guessing game, users want to ensure that the answer of the number-guessing game is predefined in the beginning, rather than changed by a host at any time. Therefore, whether the network services are secure and trustworthy is an important concern for users.

In a conventional betting service, a bettor cannot conduct a betting process unless he comes to the betting site personally. A network betting service comes to the market to solve the inconvenience. A bettor guesses the winning number through the network, and waits for a period of time to know whether he is the bet winner. Such a network betting service indeed solves some of the problems discussed previously. However, how to ensure that the betting process is fair and trustworthy is another issue for the network betting services. Since the lottery number will not be published until a betting process is over, bettors will doubt whether the lottery number is predefined or is changed after the bettors have chosen their betting numbers. Therefore, a verification mechanism is very important for the network betting services.

Therefore, how to find a trust-worthy online betting service, especially those having a real-time feedback betting process that allows a bettor to know the betting result immediately and to identify the betting result reversely in order to ensure that the betting host does not cheat, is becoming an urgent issue in the art.

### SUMMARY OF THE INVENTION

In view of the above-mentioned problems of the prior art, the present invention provide a real-time betting, drawing and winning system and method thereof, for providing a real-time betting, drawing and winning online betting service.

The present invention provides a fair and trustworthy only betting service. A bettor is allowed to identify the lottery number reversely to ensure that the lottery number is predefined and is not changed during the betting process.

In order to achieve the aforesaid objective and other objectives, the present invention provides a real-time betting, drawing and winning system, for a bettor to conduct an online betting service, the system comprising: a user device and a service server, wherein the user device is used for the bettor to bet online via a betting interface. The service server is connected to the user device via a network, and includes a lottery number module, a betting module, a comparing module and a verifying module. The lottery number module generates a lottery number in advance, generates a verification public key and a signing code according to the lottery number, and stores a verification private key corresponding to the lottery number. The betting module displays the verification public key and the signing code via the betting interface, for the bettor to select a betting mechanism via the betting interface to generate a betting item corresponding to the betting mechanism according to the betting mechanism, for the bettor to select the betting item via the betting interface to generate a betting content. The comparing module compares the betting content with the lottery number to generate lottery information, and transmits the lottery number and the lottery information to the betting interface. The verifying module allows the bettor to verify the lottery number by using the verification public key, the signing code, and verification private key from the lottery number module.

In an embodiment, the real-time betting, drawing and winning system includes at least one proxy server disposed in different regions or countries and connected to the service server, for a bettor in the regions or countries to be connected to the service server via the proxy server.

In another embodiment, the lottery number includes a random winning number or a constant winning number, and the betting mechanism includes selecting a betting number by the bettor himself and randomly selecting a betting number by a computer.

The present invention further provides a real-time betting, drawing and winning method, comprising the followings steps of: conducting an online betting service via a betting interface; generating a lottery number in advance, and generating a verification public key and a signing code according to the lottery number; selecting a betting mechanism, via the betting interface, to generate a betting item corresponding to the betting mechanism, for the bettor to select the betting item to generate a betting content; and comparing the betting content with the lottery number to generate lottery information, and transmitting the lottery number and the lottery information to the betting interface.

In an embodiment, the verification public key, the signing code, and verification private key corresponding to the lottery number are used to verify the lottery number.

In an embodiment, the method further comprises, prior to conducting an online betting service via a betting interface, connecting the betting interface to at least one proxy server, and conducting the online betting service via the proxy server.

In another embodiment, the lottery number includes a random winning number or a constant winning number, and the betting mechanism includes selecting a betting number by the bettor himself and randomly selecting a betting number by a computer.

Compared with the prior art, a real-time betting, drawing and winning system and method thereof according to the present invention allow a bettor to conduct an online betting service via a mobile device or a cellular phone. the service server is used for display a lottery number that is encrypted in advance and a signing code generated based on the lottery number, allowing the lottery number to be identified and trustworthy. Besides, the service server can feed back the betting result immediately, to save the precious time for the bettor. Moreover, the betting system of the present invention allows a bettor to bet worldwide in an easy and convenient manner, and to know the betting result immediately.

### BRIEF DESCRIPTION OF DRAWINGS

The invention can be more fully understood by reading the following detailed description of the preferred embodiments, with reference made to the accompanying drawings, wherein:

FIG. 1 is a functional block diagram of a real-time betting, drawing and winning system of an embodiment according to the present invention;

FIG. 2 is a flow chart illustrating a real-time betting, drawing and winning system according to the present invention;

FIG. 3 is a flow chart implementing a real-time betting, drawing and winning system according to the present invention;

FIGS. 4A-4L are betting diagrams illustrating a real-time betting, drawing and winning system according to the present invention;

FIG. 5 is a flow chart of a real-time betting, drawing and winning method of an embodiment according to the present invention; and

FIG. 6 is a functional block diagram of a real-time betting, drawing and winning system of another embodiment according to the present invention.

### DETAILED DESCRIPTION OF THE INVENTION

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

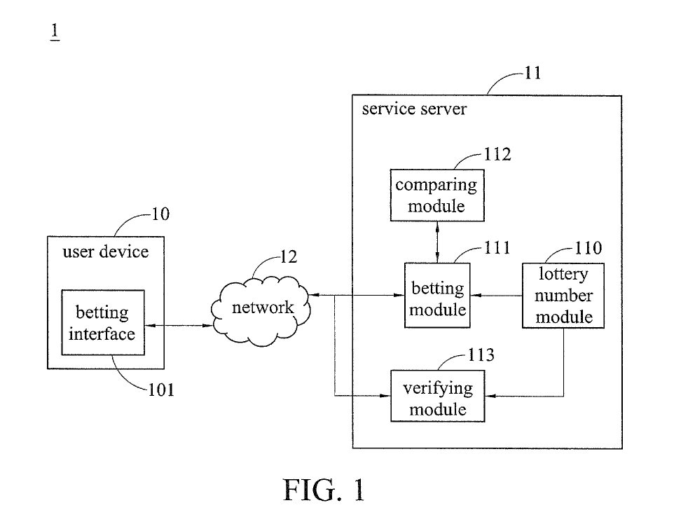

Please refer to FIG. 1, which is a functional block diagram of a real-time betting, drawing and winning system 1 of an embodiment according to the present invention. The real-time betting, drawing and winning system 1 is used for a bettor to be connected with a service server 11 via a user device 10, and the bettor is allowed to conduct network services including an online betting process and a real-time drawing and winning process. In an embodiment, the user device 10 is any electronic device that can browse a network, including a smart phone, a cellular phone, a personal computer, a laptop computer or an apparatus that can browse a network.

The user device 10 has a betting interface 101. For a mobile device, a bettor can download an application program of the service server 11. After executing the application program, the user device 10 can be connected to the service server 11 via a network 12, and display the betting interface 101. The betting interface 101 displays corresponding information and a betting item. A bettor is thus allowed to conduct an online betting service via the betting interface 101.

The service server 11 comprises a lottery number module 110, a betting module 111, a comparing module 112 and a verifying module 113.

The lottery number module 110 generates a lottery number in advance, generates a verification public key and a signing code according to the lottery number, and stores a verification private key corresponding to the lottery number. During each betting and winning process, the lottery number module 110 generates a lottery number, and generates a verification public key, a signing code and a verification private key corresponding to the lottery number by internal calculations such as encryption algorithms, for a bettor to conduct a verification process thereafter, in order to ensure that the real-time betting, drawing and winning system 1 is trustworthy.

The betting module 111 displays a verification code and a signing code by the betting interface 101 before the betting process, allowing a bettor to select a betting mechanism via the betting interface 101. The service server 11 provides a variety of betting mechanisms, such as a constant winning number and a random winning number. Different betting mechanisms correspond to different betting processes. The betting module 111 generates a corresponding betting item according the betting mechanism selected by the bettor, and the bettor is allowed to select a betting item via the betting interface 101 to generate a betting content.

The comparing module 112 compares the betting content selected by the bettor via the betting module 111 with the lottery number from the lottery number module 110, and determines whether the betting wins and generates lottery information. The lottery number and the lottery information are transmitted to and displayed on the betting interface 101, to inform the bettor of the betting result.

In order to dispel the bettor's doubt as to whether the network betting is trustworthy and whether the lottery number is correct, the present invention provides a verification mechanism, allowing a bettor to identify the lottery number. However, the identification mechanism is not necessary, and can be performed on the bettor's demands.

The verifying module 113 allows a bettor to verify the lottery number with the verification public key, the signing code, and the verification private key from the lottery number module, which are known by the bettor before he bets. In practice, the bettor can, after the lottery number is disclosed, input the verification public key and the signing code that he already knew into the verifying module 113, and the verifying module 113 will pick up the verification private key generated corresponding to the lottery number from the lottery number module 110. The verifying module 113 can calculate the data reversely through the verification public key, the signing code and the verification private key to identify whether the data are matched. If the data are matched, the lottery number is trustworthy.

In an embodiment, a lottery number generated by the lottery number module 110 comprises a random winning number or a constant winning number. An appropriate winning number generation mechanism can be provided according to different game rules and different winning probability. The random winning number refers to a winning number that is generated independently and randomly. The constant winning number refers to a winning number that is selected in advance and does not change for the whole betting process. However, such an issue relates to winning probability, further description hereby omitted.

A bettor can select different betting mechanisms via the betting interface 101. In general, the betting mechanisms include selecting a betting number by the bettor himself and randomly selecting a betting number by a computer. If the winning number is predefined, selecting a betting number by the bettor himself refers to a scenario that a bettor selects a betting content, and randomly selecting a betting number by a computer refers to another scenario that a computer selects a betting content by a random program. Since the winning number is predefined and the verification public key and the signing code are displayed and given to the bettor before he bets, a verification mechanism is thus formed. Therefore, the winning number will not be changed, no matter which winning mechanism is adopted. The most simplest betting content is guessing a combination of the head and tail of a coin, for example, guessing the combination of the head and tail of a coin after the coin is tossed a couple of times. In an embodiment, a betting item that is used for a bettor to bet allows the bettor to select the head or the tail for a designated number of times (e.g., 30 times), and the betting content shows the combination of the head(s) and tail(s). Further descriptions are in the following paragraphs.

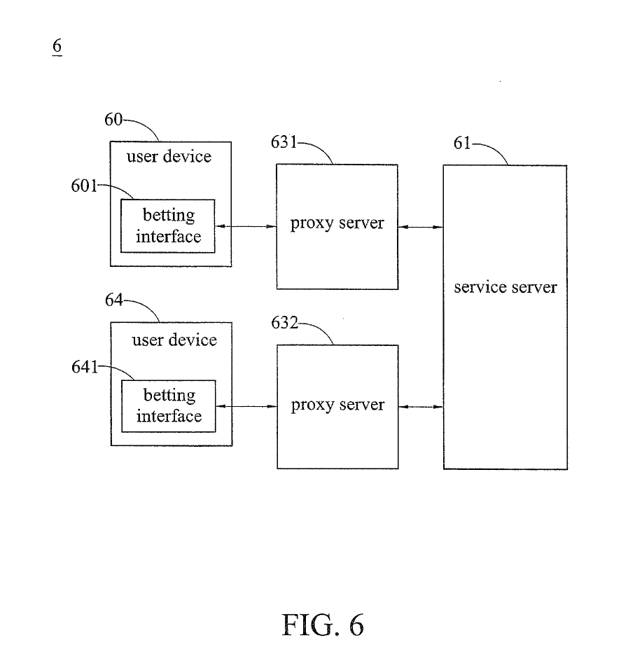

In addition to the components of the real-time betting, drawing and winning system 1 shown in FIG. 1, a real-time betting, drawing and winning system 6 described in another embodiment according to the present invention further comprises at least one proxy server, e.g., proxy servers 631 and 631 (shown in FIG. 6). The proxy server 631 acts as a connection interface between a user device 60 having a betting interface 601 and a service server 61. The proxy server 632 acts as another connection interface between a user device 64 having a betting interface 641 and the service server 61. In an embodiment, the real-time betting, drawing and winning system 6 can comprise any number of proxy servers, which are disposed in different regions or countries (e.g., US, China, Macau, Japan, Singapore, Europe Community, etc.). Therefore, a bettor is allowed to select any one of the proxy servers or be connected to one of the proxy servers that is disposed nearest to where he stays, and be connected to the service server 61. Thus, the service server 61 has a connection load reduced.

In an embodiment, the proxy servers provide different online betting services. Accordingly, a bettor is allowed to be connected to one of the proxy servers that provides one of the online betting services that he likes. Therefore, the functionalities of the proxy servers are differentiate from one another definitely, and the connection load of the service server 61 can be reduced. If the proxy servers are run by different companies, the account will not be complicated.

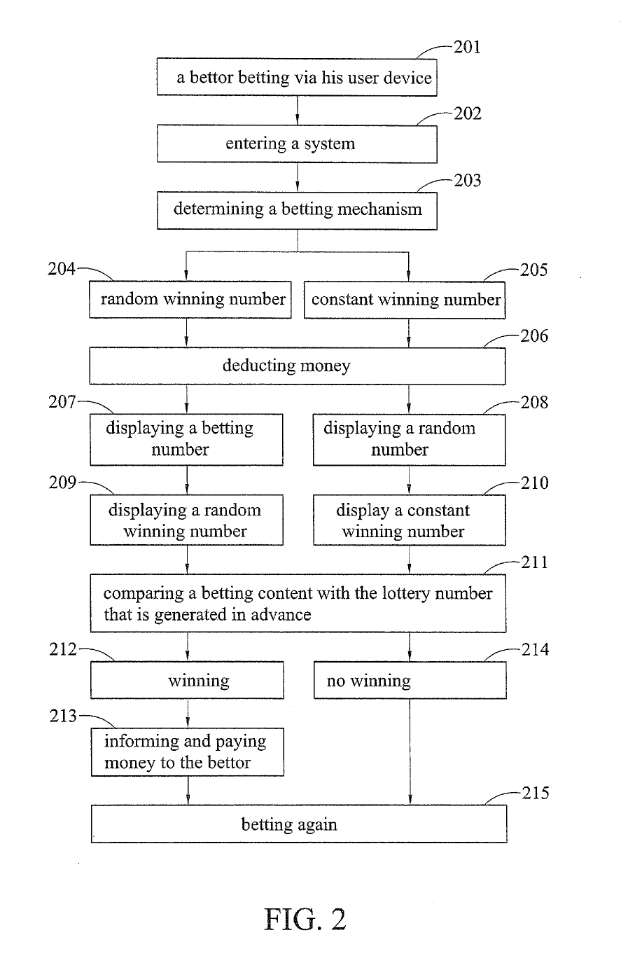

Please refer to FIG. 2, which is a flow chart illustrating the real-time betting, drawing and winning system 1 according to the present invention. Online betting and winning processes can be performed according to the real-time betting, drawing and winning system 1 and the modules thereof.

In step 201, a bettor bets via his user device (e.g., a cellular phone). In step 202, the bettor is connected to a service server via his user device and an application program, and the service server provides corresponding information to the bettor. In step 203, the bettor is requested to determine a betting mechanism that he wants to execute, the betting mechanism including a random winning number shown in step 204 or a constant winning number shown in step 205, both of which are described previously, further description hereby omitted.

In step 206, the service server charges the bettor by deducting betting money from the bettor's deposit account in the service server, charging the bettor's credit card, or deducting betting money from the bettor's deposit account in a designated bank. In order to increase the trustworthy characteristic of the betting process, verification data (i.e., the verification public key and the signing code) for the betting content is shown to the bettor, as shown in steps 207 and 208.

In steps 209 and 210, the bettor selects a betting content, and the service server compares the betting content with the winning number that is generated in advance, as shown in step 211. If the betting content and the winning number are matched, proceed to step 212. In step 212, a message indicating that the bettor wins is shown. In step 213, winning money is paid. If the betting content and the winning number are not matched, proceed to step 214. In step 214, another message indicating that the bettor does not win is shown. Both steps 213 and 214 proceed to step 215, in which the bettor is asked if he wants to bet again.

The above-described betting and winning processes are basic processes for a real-time betting, drawing and winning system according to the present invention. Further processes are described in the following paragraphs.

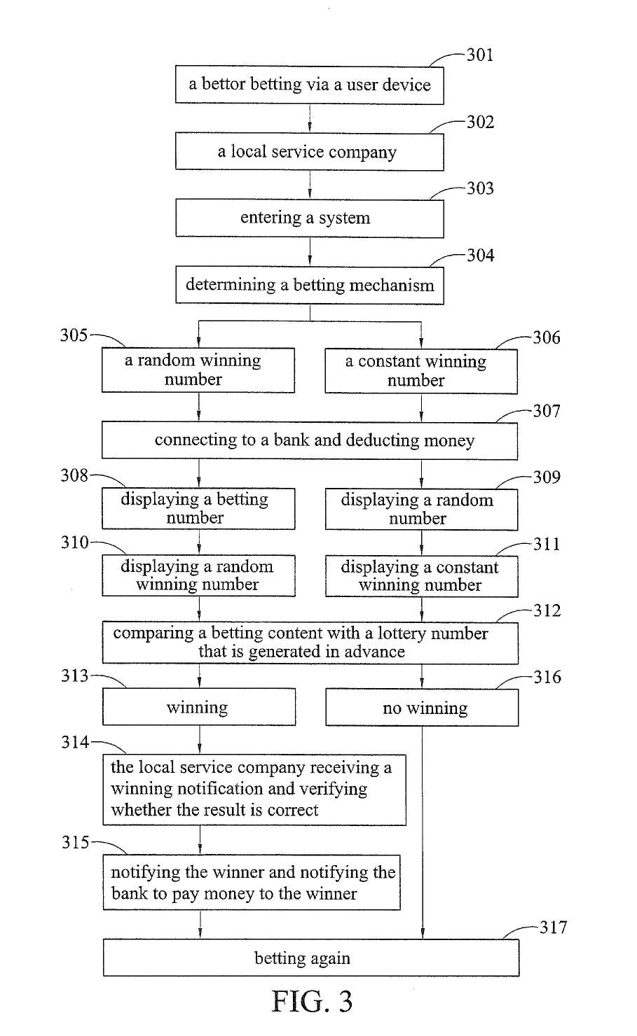

Please refer to FIG. 3, which is a flow chart implementing a real-time betting, drawing and winning system according to the present invention. The flow chart is also used to illustrate the online betting and winning processes based on the real-time betting, drawing and winning system 1 shown in FIG. 1.

In step 301, a bettor is allowed to bet via his user device. In step 302, the bettor selects a local service company to which he wants his user device to be connected. In an embodiment, the local service company can be categorized based on regions or game types. After the user device is connected to the local service company, a service server provides corresponding information to the bettor. After the bettor reads the corresponding information, his user device can be connected to the service server, as shown in step 303. In step 304, the service server requests the bettor to determine a betting mechanism that he wants to execute, including a random winning number shown in step 305 or a constant winning number shown in step 306.

In step 307, the service server is connected to a designated bank to verify the identification of the bettor and determine as to whether money is deducted from the bank, e.g., by deducting betting money from the bettor's deposit account in the service server, charging the bettor's credit card, or deducting betting money from the bettor's deposit account in a designated bank. In order to increase the trustworthy characteristic of the betting process, verification data (i.e., the verification public key and the signing code) for the betting content is shown to the bettor, as shown in steps 308 and 309. The verification data is used for the bettor to conduct a verification process after the betting process.

In steps 310 and 311, the bettor selects his betting content. In step 312, the service server compares the betting content with the winning number that is generated in advance. If the betting content and the winning number are matched, proceed to step 313. In step 313, a message indicating that the bettor wins is shown. In step 314, the local service company is notified of the winning message from the service server and verifies the winning content. In step 315, the bettor is notified and the bank is notified to pay the winning money. If the betting content and the winning number are not matched, proceed to step 316. In step 316, another message indicating that the bettor does not win is shown. Both the steps 315 and 316 proceed to step 317, in which the bettor is asked if he wants to bet again.

In the flow chart, network service providers and the local service company or other commission payment are involved. An account process is further performed to distribute the revenue after the deduction of the winning money from the betting amount. A designated portion, e.g., 40%, of the revenue can be donated to any country where the real-time betting, drawing and winning system is disposed, in order to enhance the willing of the country to install the system and increase the income of the country.

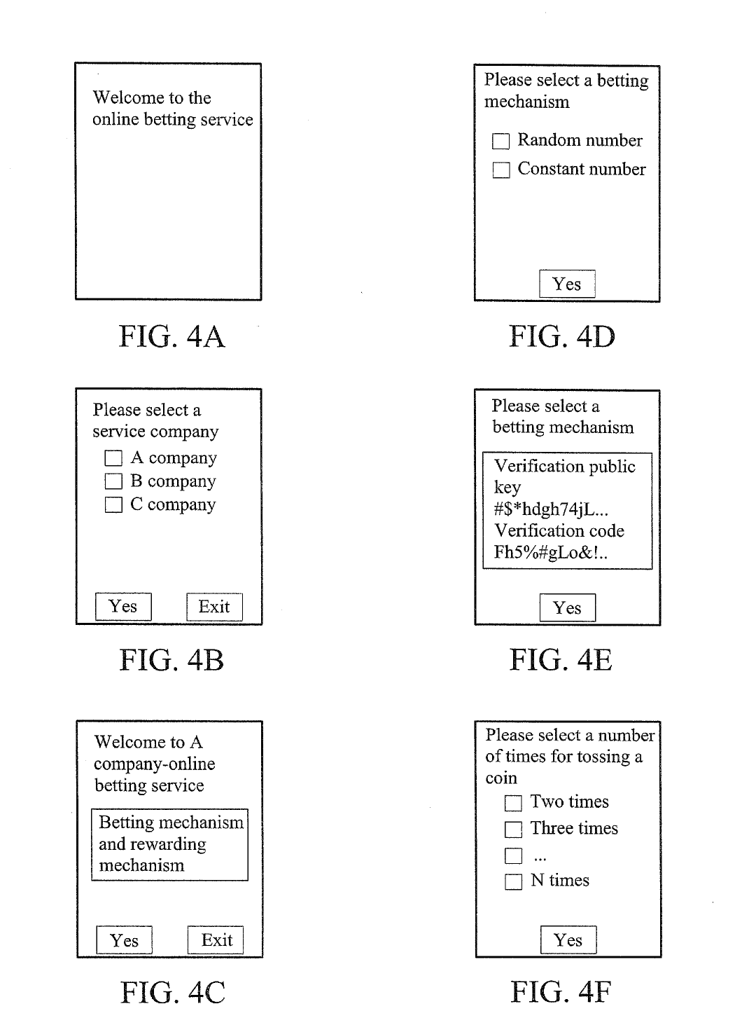

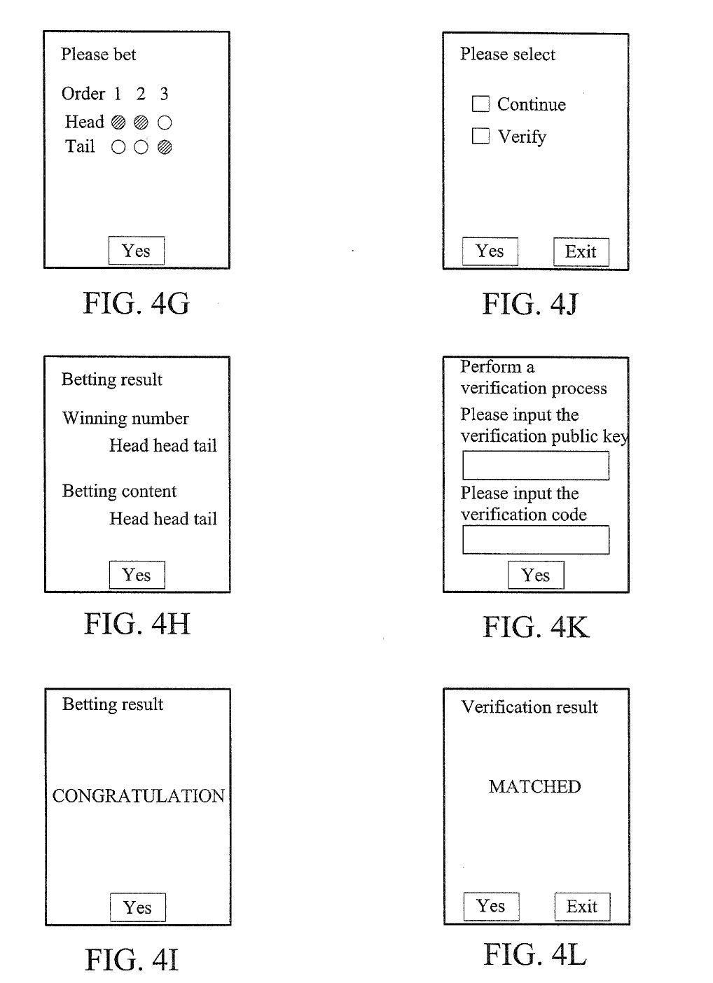

FIGS. 4A-4L show betting and winning processes in a real-time betting, drawing and winning system according to the present invention. A variety of aspects in the embodiment are described accompanying with FIGS. 4A-4L and FIGS. 1-3. FIGS. 4A-4L show the display contents of the betting interface on the user device.

As shown in FIG. 4A, after a bettor executes an application program of a service server, a betting interface shows words indicating that an online betting service is performed.

As shown in FIG. 4B, the bettor selects an interface service company. As described previously, service companies can be categorized based on regions or service types. The bettor can select one of the service companies to conduct an online betting process.

As shown in FIG. 4C, as the bettor selects an interface service company, the service server displays betting mechanisms and money rewarding mechanisms to the bettor, and informs the bettor of notice items, including “Yes” and “Exit.” If “Yes” is clicked, a betting process is conducted. If the bettor does not agree, he may click “Exit.” The service server then deducts money according to a money deduction mechanism.

As shown in FIG. 4D, the betting interface displays the betting mechanisms, allowing the bettor to select one of them and conduct a betting process. In an embodiment, the service server provides a random number or a constant number, like the lottery number described in the previously described embodiments that has a random winning number or a constant winning number.

As shown in FIG. 4E, after the bettor selects one of the betting mechanisms, the betting interface displays a verification public key and a verification code of the selected betting mechanism, and the bettor can use them to perform a verification process after the betting process is complete. Therefore, it is necessary for the betting interface to show the verification public key and the verification code, which indicates that the lottery number will not be changed.

As shown in FIG. 4F, the betting interface shows a variety of betting contents that the bettor can select. In a coin-tossing game, the more the times that the coin is tossed, the more difficult for any one to guess the correct combination, which relates to winning money distribution and winning difficulty. In an embodiment,

$${C}_{x}^{n} {{p}^{x} ( 1 - p )}^{n - x} ( e . g . , {{C}_{2}^{8} ( \frac{1}{2} )}^{2} {( \frac{1}{2} )}^{6} = 0.1094 )$$

is provided as a basis for processing the winning money distribution and the winning difficulty, where n denotes a number of times that the coin is tossed, x denotes a number of times that the head of the coin is guessed correctly, P denotes the probability that the head of the coin is guessed correctly, and Q denotes a number of times that the tail of the coin is guessed correctly, in order to calculate the winning money. In an example, in which a bettor is allowed to toss a coin ten times and the betting money is one dollar, a bettor, if wins, can get 250 dollars. In another example, in which a bettor is allowed to toss the coin 30 times and the betting money is also one dollar, the bettor, if wins, can obtain one hundred million dollars. In these two examples, the government can get 40% of the revenue. In an embodiment, the betting mechanism can also be applied to any type of number-betting process. Accordingly, a real-time betting system according to the present invention includes any type of number betting content, which is obtained based on a numeral operation such as

$${C}_{n}^{x} \times {C}_{k}^{y} ( e . g . , {C}_{60}^{5} \times {C}_{50}^{1} = \frac{1}{5 \text{,} 461 \text{,} 512} \times \frac{1}{50} = \frac{1}{273 \text{,} 075 \text{,} 600} ) ,$$

which has betting contents and betting steps completely the same as those described previously.

As shown in FIG. 4G, the betting interface shows selection contents, and a bettor is requested to input his betting content. In an embodiment, the bettor selects tossing three times in FIG. 4F, and the betting interface shown in FIG. 4G requests the bettor to guess results that are generated sequentially as the coin is tossed three times. In order to protect the rights of the service end and the bettor, including the bettor conducting no betting process or the service end worrying that the lottery number is solved, the bettor is required to complete in a limited time, e.g., 10 minutes. If the time runs out, the betting interface displays as shown in FIG. 4D. In an embodiment, the bettor selects “head, head, tail.”

As shown in FIG. 4H, after the bettor selects his betting content in FIG. 4G, the betting interface displays a betting result, including the winning number and the betting content. Then, FIG. 4I shows a message indicating whether the bettor wins.

As described in the previous embodiments, the present invention provides a trustworthy real-time betting, drawing and winning system. Therefore, after the betting process is complete, a bettor is allowed to verify the lottery number.

As shown in FIG. 4J, after the betting process is complete, the betting interface will ask the bettor if he will continue or perform a verification process. If the bettor selects performing the verification process, as shown in FIG. 4K, the service server will request the bettor to input or the service server inputs, by itself, the verification public key and the verification code obtained before he bets, and the service server performs a reverse calculation with the verification public key and the verification code and the verification private key generated corresponding to the generation of the verification public key and the verification code, to determine whether the verification public key, the verification code and the verification private key are generated by lottery number. A verification result is shown in FIG. 4L.

If the bettor does not select the verification process in FIG. 4J, he may select bet again or exit after FIG. 4L shows the verification result.

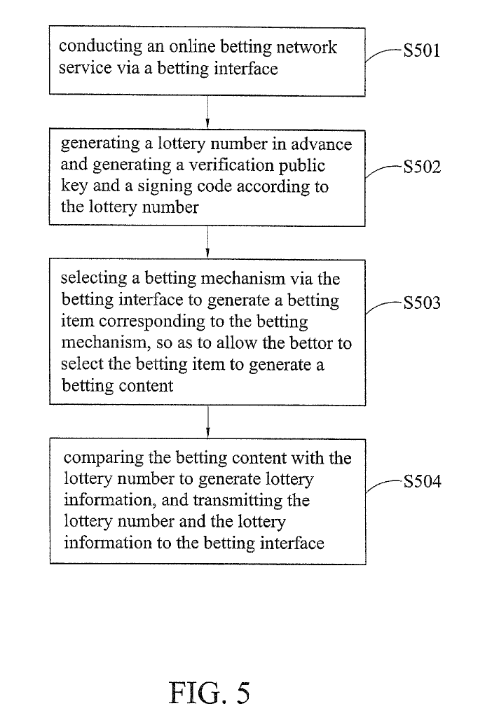

Please refer to FIG. 5, which is a flow chart of a real-time betting, drawing and winning method of an embodiment according to the present invention. The real-time betting, drawing and winning method indicates that a bettor can be connected via a user device to a service server that performs a real-time betting process to conduct an online betting process and know the betting result immediately. The method begins in step S501.

In step S501, a betting interface is used to conduct an online betting service. A bettor is allowed to be connected via a betting interface of his user device to a service server that conducts a real-time betting process, to obtain network services provided by the service server. The method proceeds to step S502.

In step S502, a lottery number is generated in advance and a verification public key and a signing code are generated according to the lottery number. When the bettor bets, the service server has already generated the lottery number in advance. In order to achieve the verification objective, the lottery number can be encrypted by various encryption algorithms, to generate a verification public key, a verification private key and a signing code, wherein the verification public key and the signing code are shown on the betting interface, allowing the bettor to know and used for a subsequent verification process. The verification private key is stored in the service server.

In an embodiment, the lottery number includes a random winning number or a constant winning number. In other words, the winning number is generated randomly for every betting process or is constant. The method proceeds to step S503.

In step S503, the betting interface selects a betting mechanism to generate a betting item corresponding to the betting mechanism, to allow the bettor to select the betting item and generate a betting content. Before the bettor bets, a money deduction process or an identification verifying process may be performed. In step S503, the bettor can select a betting mechanism via the betting interface, and selects a betting item that is generated by the corresponding betting mechanism, to generate a betting content.

In an embodiment, the betting mechanism includes selecting a betting number by the bettor himself and randomly selecting a betting number by a computer. Therefore, the bettor can select a betting content himself or the computer select a betting content randomly. The lottery number is predefined in advance, and will not change with the betting content. The method proceeds to step S504.

In step S504, the betting content is compared with the lottery number, and the lottery number and the lottery information are transmitted to the betting interface. In step S504, the service server compares the betting content with the lottery number, to determine whether the bettor wins this time, and transmits the lottery information back to the betting interface. The lottery information is displayed on the betting interface.

In the verification process, the bettor is allowed to verify the lottery number with the verification public key and the signing code, and the service server calculates the verification public key, the verification private key and the signing code reversely, to obtain the verification result. However, the bettor can or cannot perform the verification process, on his demands.

In another embodiment, step S501 further comprises connecting the betting interface to at least one proxy server, and conducting the online betting service via the proxy server. In order to reduce the load of the service server or disperse the bettors into different regions, a plurality of proxy servers can be disposed between the user device and the service server. The user device is connected to the service server via one of the proxy servers.

Given the above, a real-time betting, drawing and winning method according to the present invention provides trustworthy online betting process and betting result. Before the betting process, the bettor already knew the verification public key and the verification code that correspond to the lottery number for the betting process. The bettor can verify whether the winning number is trustworthy with the verification public key and the verification code, and can feel at ease in conducting an online betting process.

Besides, a real-time betting, drawing and winning system and method according to the present invention can be applied to a variety of network betting mechanism, including, but not limited to lottery activities held by lottery stores, convenient stores and department stores.

In summary, a real-time betting, drawing and winning system and method according to the present invention allow a bettor to conduct an online betting process via a mobile device or a cellular phone. A service server displays a lottery number that is encrypted in advance and a signing code that is generated according to the lottery number. Therefore, the lottery number is verifiable and is trustworthy. The service server can feedback the betting result immediately. Therefore, the bettor can conduct an online betting process anytime and anywhere, and know the betting result immediately. A real-time betting, drawing and winning system according to the present invention provides the bettor better and more attractive network services.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A real-time betting, drawing and winning system, for a bettor to conduct an online betting service, the system comprising:
a user device used for the bettor to bet on-line via a betting interface; and
a service server connected to the user device via a network and comprising:
a lottery number module generating a lottery number in advance, generating a verification public key and a signing code according to the lottery number, and storing a verification private key corresponding to the lottery number;
a betting module displaying the verification public key and the signing code via the betting interface to allow the bettor to select a betting mechanism via the betting interface, and generating a betting item corresponding to the betting mechanism according to the betting mechanism to allow the bettor to select the betting item via the betting interface to generate a betting content;
a comparing module comparing the betting content with the lottery number to generate lottery information, and transmitting the lottery number and the lottery information to the betting interface; and
a verifying module used for the bettor to verify the lottery number by using the verification public key and the signing code and the verification private key from the lottery number module.

2. The real-time betting, drawing and winning system of claim 1, further comprising at least one proxy server disposed on different regions or countries and connected to the service server, allowing the user device in the regions or countries to be connected with the service server via the proxy server.

3. The real-time betting, drawing and winning system of claim 1, wherein the lottery number includes a random winning number or a constant winning number.

4. The real-time betting, drawing and winning system of claim 1, wherein the betting mechanism includes selecting a betting number by the bettor himself and randomly selecting a betting number by a computer.

5. The real-time betting, drawing and winning system of claim 1, wherein the betting content indicates a combination of two opposite selections that are selected sequentially for a designated number of times.

6. The real-time betting, drawing and winning system of claim 1, wherein the real-time betting, drawing and winning system provides Cₓⁿp^{x}(1−p)^{n-x} or Cₙ^{x}×Cₖ^{y} numeral operation as a basis for processing winning money distribution and winning difficulty.

7. A real-time betting, drawing and winning method, comprising the followings steps of:
(1) conducting an online betting service via a betting interface;
(2) generating a lottery number in advance, and generating a verification public key and a signing code according to the lottery number;
(3) selecting a betting mechanism, via the betting interface, to generate a betting item corresponding to the betting mechanism, for the bettor to select the betting item to generate a betting content; and
(4) comparing the betting content with the lottery number to generate lottery information, and transmitting the lottery number and the lottery information to the betting interface.

8. The real-time betting, drawing and winning method of claim 7, wherein step (1) further comprises connecting the betting interface to at least one proxy server, and conducting the online betting service via the proxy server.

9. The real-time betting, drawing and winning method of claim 7, wherein the lottery number includes a random winning number or a constant winning number, and the betting mechanism includes selecting a betting number by the bettor himself and randomly selecting a betting number by a computer.

10. The real-time betting, drawing and winning method of claim 7, wherein the verification public key and the signing code are used with the verification private key corresponding to the lottery number to verify the lottery number.
